(19) United States
(12) Patent Application Publication
(10) Pub. No.: US 2019/0383232 A1
(43) Pub. Date: Dec. 19, 2019

(54) GAS ENGINE DRIVEN HEAT PUMP SYSTEM WITH GENERATOR

(71) Applicant: KITURAMI CO., LTD., Cheongdo-gun (KR)

(72) Inventors: Wan-Yong SEONG, Suwon-si (KR); Woo-Hwa LEE, Gwangju-si (KR); So-Hyun KIM, Cheonan-si (KR)

(73) Assignee: KITURAMI CO., LTD., Cheongdo-gun (KR)

(21) Appl. No.: 16/014,910

(22) Filed: Jun. 21, 2018

(30) Foreign Application Priority Data
Jun. 14, 2018 (KR) 10-2018-0068179

(51) Int. Cl. F02G 5/04; F01P 3/18; F01P 5/12; F01P 7/14; F25B 27/02; F25B 30/02; F25B 41/04; F28D 9/00

(52) U.S. Cl. CPC F02G 5/04; F01P 3/18; F01P 5/12; F01P 7/14; F25B 27/02; F02G 2280/60; F25B 41/04; F28D 9/00; F01P 2007/146; F02G 2260/00; F02G 2270/90; F25B 30/02

(57) ABSTRACT

The present invention relates to a gas engine driven heat pump system (GHP) and, more particularly, to a gas engine driven heat pump system with a generator, the system including a generator that is driven to generate power by a gas engine in addition to driving a compressor by driving the gas engine, thereby using external power only in the early-state operation and, later, being able to drive a gas hat pump using self-power generated by the generator without using specific external power and to supply the power to an energy storage system (ESS) storing power and a power system requiring power in buildings, and the system further supplying hot water by restoring engine waste heat.

### CROSS REFERENCE TO RELATED APPLICATION

The present application claims priority to Korean Patent Application No. 10-2018-0068179, filed Jun. 14, 2018, the entire contents of which is incorporated herein for all purposes by this reference.

### BACKGROUND OF THE INVENTION

### Field of the Invention

The present invention relates to a gas engine driven heat pump system (GHP) and, more particularly, to a gas engine driven heat pump system with a generator, the system including a generator that is driven to generate power by a gas engine in addition to driving a compressor by driving the gas engine, thereby using external power only in the early-state operation and, later, being able to be operated by self-power generated by the generator without using specific external power and to supply the power to an energy storage system (ESS) storing power and a power system requiring power in buildings, and the system further supplying hot water by restoring engine waste heat.

### Description of the Related Art

In general, a gas engine driven heat pump system is a system that has a cooling cycle and a heating cycle and performs a cooling or heating operation using gas as fuel.

In general, a gas engine driven heat pump system should supply power for driving a plurality of pumps, a plurality of electric valves, and electronic devices that are provided to circulate refrigerant and cooling water in the system. The power is supplied from an external power facility requiring specific electric charges.

Furthermore, a gas engine driven heat pump system may be operated in cooperation with a hot water supply system to supply hot water.

In general, a hot water supply system produces hot water using the heat that is produced by heat exchange between refrigerant and a predetermined heat accumulation device when a gas engine driven heat pump system is operated in a cooling cycle or a heating cycle.

Accordingly, the gas engine driven heat pump systems of the related art produces hot water using the heat that is provided in cooling/heating cycle, so the thermal efficiency is deteriorated.

In order to solve this problem a gas heat-pump system that produces hot water using waste heat from an engine has been used (hereafter, referred to as prior art).

However, the prior art requires specific external power to drive pumps, valves, and electronic devices etc., additional electric charges are incurred.

Furthermore, the prior art cannot use waste heat from a gas engine separately for a cooling mode and a heating mode, so the efficiency is low.

### SUMMARY OF THE INVENTION

An object of the present invention is to provide a gas engine driven heat pump system with a generator, the system including a generator that is driven to generate power by a gas engine in addition to driving a compressor by driving the gas engine, thereby using external power only in the early-state operation and, later, being able be operated by self-power generated by the generator without using specific external power and to supply the power to an energy storage system (ESS) storing power and a power system requiring power in buildings, and the system further supplying hot water by restoring engine waste heat.

According to an aspect of the present invention, there is provided a gas engine driven heat pump system with a generator, the system including a gas engine, an outdoor heat exchange unit performing heat exchange with external air, an expansion valve unit expanding and discharging refrigerant condensed by the outdoor heat exchange unit in a cooling cycle and a heating cycle, and a heating plate heat exchanger transmitting heat to the refrigerant decreased in temperature and expanded by the outdoor heat exchange unit and the expansion valve unit, the system comprising: a generator driven by the gas engine to generate power; and a generator-cooling circulation unit including a cooling water tank supplementing a generator-circulation cooling water pipeline, which connects the generator and the outdoor heat exchange unit in circulation, with cooling water using pressure generated in the a generator-circulation cooling water pipeline, and a generator-cooling water pump pumping the cooling water in the generator-circulation cooling water pipeline to circulate the cooling water to the generator and the outdoor heat exchange unit.

The outdoor heat exchange unit may include a generator radiator discharging heat of the cooling water increased in temperature through the generator, in the generator-circulation cooling water pipeline, to the outside.

The system may further include: a hot water generation unit including a hot water accumulation tank keeping water to be heated and receiving and keeping heated hot water, a hot water pump circulating water in the hot water accumulation tank through a hot water pipeline, and a hot water plate heat exchanger receiving the water supplied by the hot water pump and heated cooling water and transmitting heat of the heated cooling water to the water supplied by the hot water pump; an engine-cooling water tank keeping cooling water and supplementing a cooling/heating pipeline with cooling water; a waste heat-cooling water circulation controller controlling cooling water to form a first flow in which cooling water in a waste heat-cooling water pipeline circulates through the gas engine, the hot water plate heat exchanger, and the gas engine and a second flow in which the cooling water circulates through the gas engine, the outdoor heat exchange unit, and the gas engine in a cooling cycle in the cooling cycle, and controlling cooling water to form a first flow in which the cooling water circulates through the gas engine, the hot water plate heat exchanger, and the gas engine and a second flow in which the cooling water circulates through the gas engine, the outdoor heat exchange unit, the heating plate heat exchanger, and the gas engine in the heating cycle; and a waste heat-cooling water pump pumping the cooling water in the waste heat-cooling water pipeline to circulate the cooling water.

The waste heat-cooling water circulation controller may include: a first 3-way valve receiving cooling water increased in temperature by waste heat from the gas engine and discharging the cooling water in a first direction and a second direction in the heating cycle and the cooling cycle; a third 3-way valve receiving the cooling water discharged in the second direction and supplying the cooling water to the gas engine through the hot water plate heat exchanger in the cooling cycle and the heating cycle; and a second 3-way valve receiving the cooling water discharged in the first direction, and discharging the cooling water to the outdoor heat exchange unit in the cooling cycle and to the outdoor heat exchange unit and the heating plate heat exchanger in the heating cycle.

The system may further include an exhaust gas heat exchanger controlling temperature of cooling water flowing into an engine by transmitting heat of engine exhaust gas to the cooling water in early-stage operation.

The system may further include an inverter module disposed in the generator-circulation cooling water pipeline to remove heat discharged from the cooling water

The compressor may be driven by power from the engine.

According to the present invention, since electricity is generated by driving a generator using a gas engine and is used for the gas engine driven heat pump system, there is no need for paying for electric charges for using external power, so it is possible to reduce the costs for driving the gas engine driven heat pump system.

Furthermore, since it is possible to generate large-capacity power through the generator and supply the power to external systems such as an energy storage system and a power system in buildings, it is possible to minimize electricity charges for using external power in buildings equipped with the gas engine driven heat pump system of the present invention.

Furthermore, since a separate cooling water circulation line including a generator and an outdoor heat exchange unit is configured to remove heat of the generator, the heat of the generator can be efficiently removed.

Furthermore, it is possible to produce hot water and perform defrosting operation using waste heat from an engine, so energy efficiency can be increased.

Furthermore, since it is possible to process waste heat by a heating cycle and a cooling cycle, using three 3-way valves, waste heat can be more efficiently used.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a gas engine driven heat pump system including a generator according to the present invention;

FIG. 2 is a diagram showing the configuration of the gas engine driven heat pump system including a generator and showing the circulation direction of a coolant and cooling water in a cooling cycle according to the present invention;

FIG. 3 is a diagram showing the configuration of the gas engine driven heat pump system including a generator and showing the circulation direction of a coolant and cooling water in a heating cycle according to the present invention;

FIG. 4 is a diagram showing the configuration of a generator-cooling unit in the gas engine driven heat pump system according to the present invention;

FIG. 5 is a diagram showing a cooling water circulation configuration in a heating cycle according to the present invention; and

FIG. 6 is a diagram showing a cooling water circulation configuration in a cooling cycle according to the present invention.

### DETAILED DESCRIPTION OF THE INVENTION

The configuration and operation of a the gas engine driven heat pump system including a generator according to the present invention is described hereafter in detail with reference to the accompanying drawings.

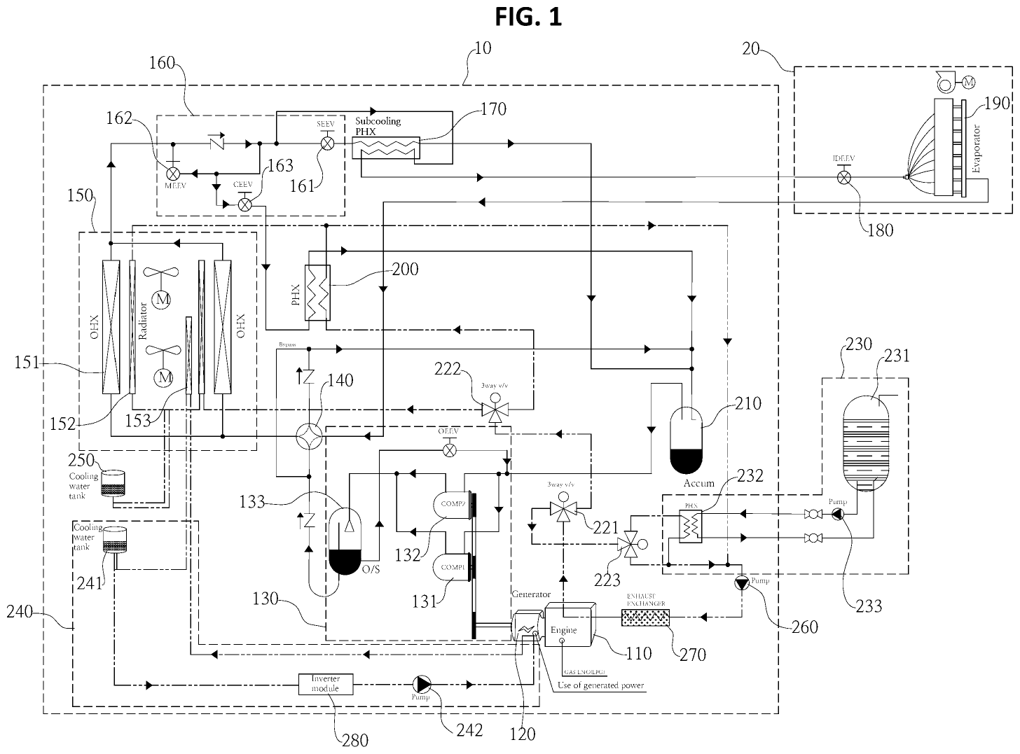

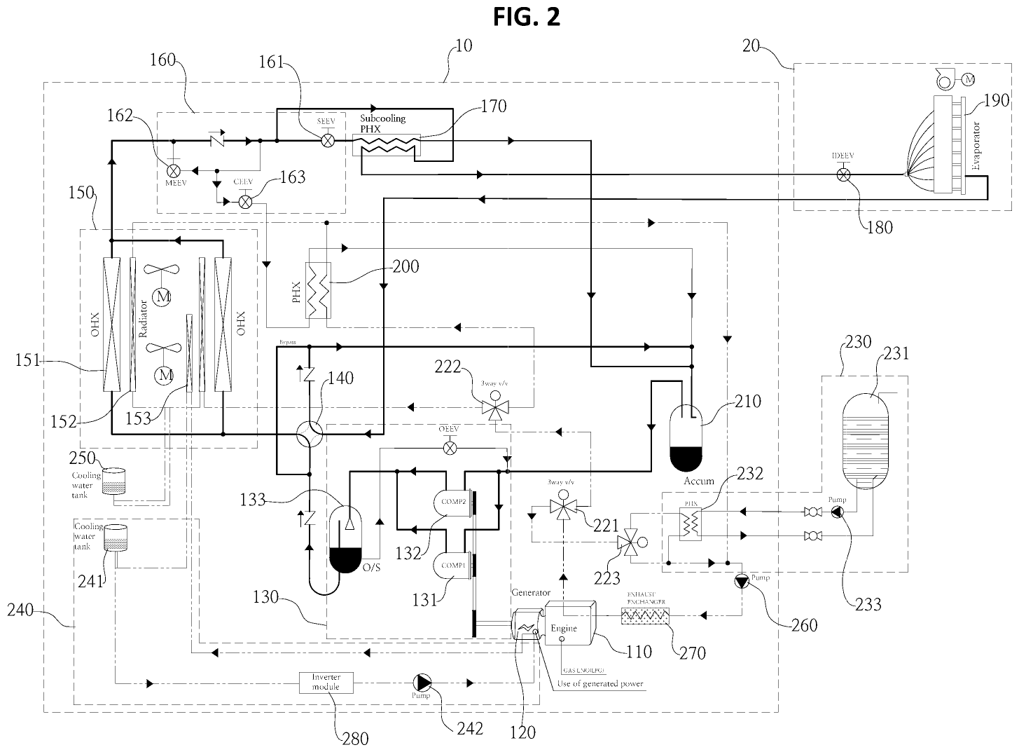

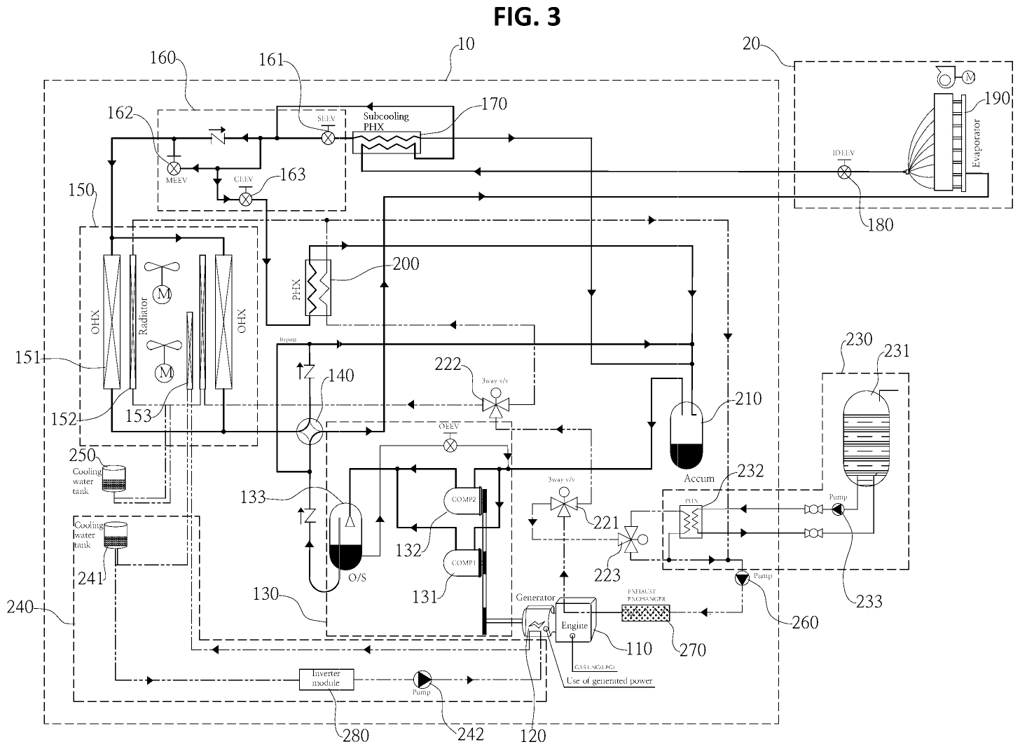

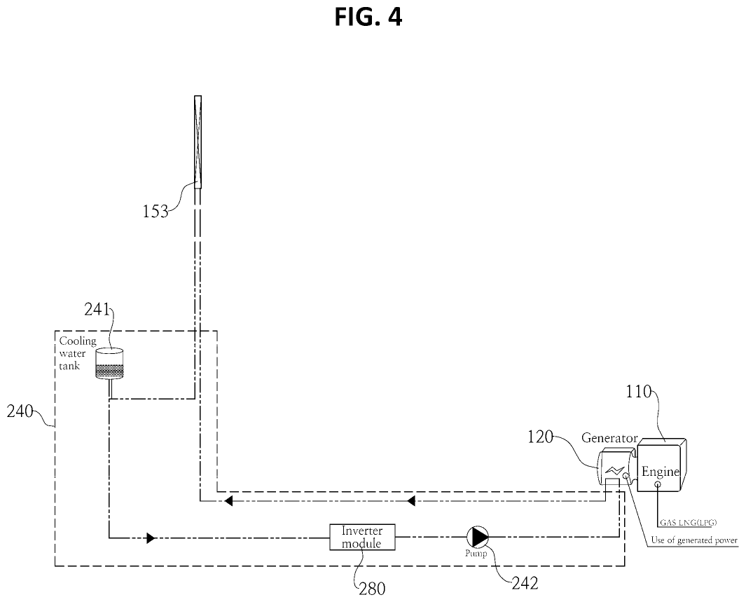

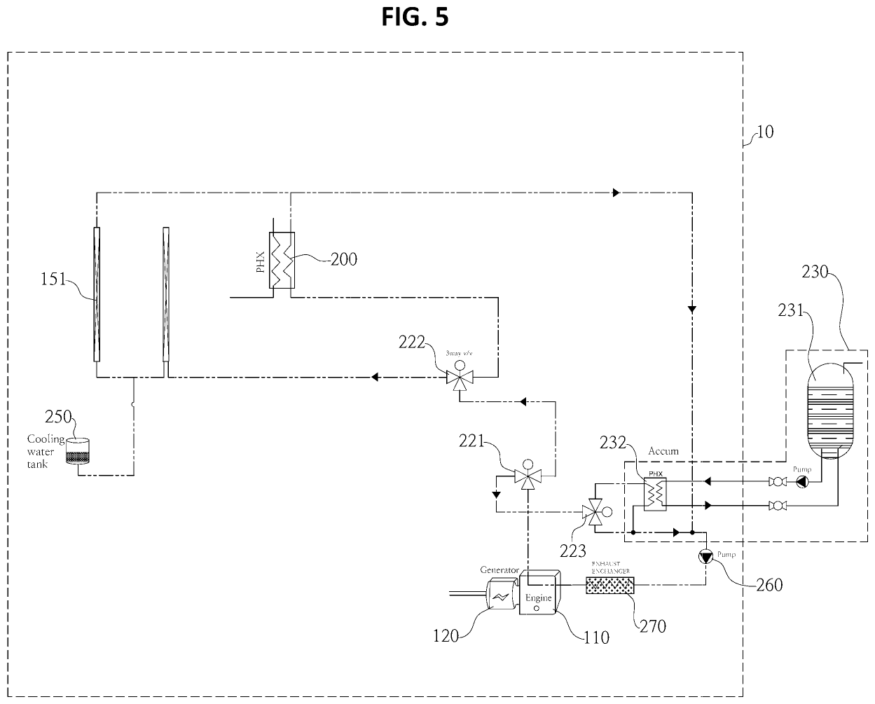

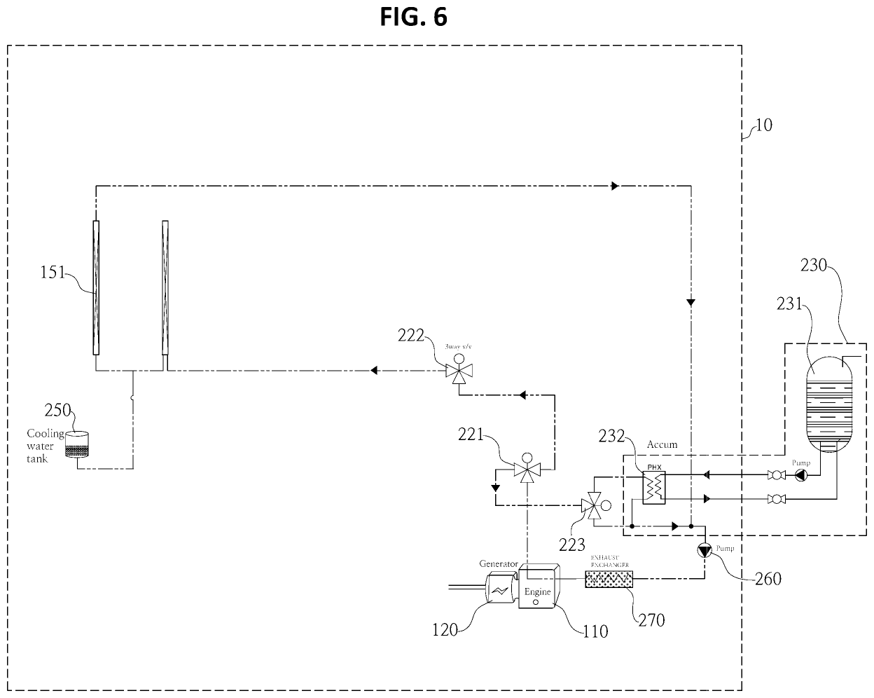

FIG. 1 is a gas engine driven heat pump system including a generator according to the present invention, FIG. 2 is a diagram showing the configuration of the gas engine driven heat pump system including a generator and showing the circulation direction of a coolant and cooling water in a cooling cycle according to the present invention, FIG. 3 is a diagram showing the configuration of the gas engine driven heat pump system including a generator and showing the circulation direction of a coolant and cooling water in a heating cycle according to the present invention, FIG. 4 is a diagram showing the configuration of a generator-cooling unit in the gas engine driven heat pump system according to the present invention, FIG. 5 is a diagram showing a cooling water circulation configuration in a heating cycle according to the present invention, and FIG. 6 is a diagram showing a cooling water circulation configuration in a cooling cycle according to the present invention.

The present invention is described hereafter with reference to FIGS. 1 to 6.

A gas engine driven heat pump system including a generator according to the present invention includes an outdoor unit 10, an indoor unit 20, and a hot water generation unit 230 sharing some components with the outdoor unit 10.

The outdoor unit 10 may include a gas engine 110, a generator 120, a compressure 130, a 4-way valve 140, an outdoor heat exchange unit (heat exchanger) 150, an expansion valve unit 160, a subcooling plate heat exchanger 170, a heating plate exchanger 200, an accumulator 210, a waste heat-cooling water circulation controller 220, a generator-cooling circulation unit 240, an engine cooling water tank 250, and a waste heat-cooling water pump 260, and depending on embodiments, it further includes an exhaust gas heat exchanger 270 and an inverter module 280.

The indoor unit 20 includes a fifth expansion valve 180 and an evaporator 190.

The gas engine driven heat pump system of the preset invention includes: a cooling/heating pipeline including pipes through which refrigerant can flow among the compressure 130, the 4-way valve 140, the outdoor heat exchange unit 150, the expansion valve unit 160, a first expansion valve 161, the subcooling plate heat exchanger 170, the fifth valve 180, the evaporator 190, the heating plate exchanger 200, and the accumulator 210; a waste cooling water pipeline including pipes through which cooling water can flow among the waste heat-cooling water pump 260, the exhaust gas heat exchanger 270, the gas engine 110, the waste heat-cooling water circulation controller 220, and the outdoor heat exchange unit 150; and a hot water pipeline disposed in the hot water generation unit 230 to circulate water or heated hot water.

The gas engine 110 generates power using gas (LNG, LPG etc.) as fuel.

The generator 120 is connected to the gas engine 110, generates electricity (power) using power from the gas engine 110, and supplies the power to components requiring power in the system of the present invention. When the generator 120 generates power, heat is generated by rotation of a motor.

The generator 120 according to the present invention generates power over 50 KW and may supply power not only to the gas engine driven heat pump system, but to external systems such as an energy storage system (ESS) and a power system in buildings equipped with the gas engine driven heat pump system of the present invention.

The compressure 130 is composed of a first compressor 131 and a second compressor 132 that are operated by power generated by the gas engine 110, and compresses and discharges refrigerant flowing inside into a high-temperature and high-pressure refrigerant.

The compressure 130 further includes an oil separator (O/S) 133 that separates and discharges oil mixed with a refrigerant in the first compressor 131 and the second compressor 132.

The 4-way valve 140 switches flow of refrigerant in accordance with modes, that is, a cooling cycle (mode) and a heating cycle (mode). In detail, in the cooling cycle, the 4-way valve 140 discharges refrigerant flowing inside from the oil separator 133 to the outdoor heat exchange unit 150 and discharges refrigerant flowing inside from the evaporator 190 to the accumulator 210.

In the heating cycle, the 4-way valve 140 discharges refrigerant flowing inside from the oil separator 133 to the evaporator 190 and discharges refrigerant flowing inside from the outdoor heat exchange unit 150 to the oil separator 210.

The outdoor heat exchange unit 150 includes an outdoor heat exchanger 151 and a radiator 152, and depending on embodiments, it further includes a generator radiator 153.

The outdoor heat exchanger 151 includes a front side and a rear side. The outdoor heat exchanger 151 can function as a condenser that condensates, liquefies, and discharges the high-temperature and high-pressure compressed refrigerant in cooling and can function as a partial evaporator in heating.

The radiator 152 includes a front side and a rear side, is a heat-dissipating heat exchanger configured to discharge heat of an engine, and is mainly used for the cooling cycle.

The generator radiator 153 is a heat-dissipating heat exchanger discharging heat of cooling water flowing inside through the inverter module 280 and the generator 120.

The expansion valve unit 160 includes a first expansion valve 161, a second expansion valve 162, and a third expansion valve 163.

The first expansion valve 161, as shown in FIG. 2, rapidly drops the temperature of the refrigerant flowing inside from the outdoor heat exchange unit 150 by expanding the refrigerant, and discharges the refrigerant to the subcooling plate heat exchanger 170 in the cooling cycle.

The second expansion valve 162 and the third expansion valve 163 are not used in the cooling cycle, as shown in FIG. 2. However, as shown in FIG. 3, the second expansion valve 162 and the third expansion valve 163, in the heating cycle, expand and reduce the pressure of the refrigerant (depressurizes the refrigerant) flowing inside from the subcooling plate heat exchanger 170 and discharge the refrigerant to the outdoor heat exchange unit 150 and the heating plate heat exchanger 200.

The subcooling plate heat exchanger 170 supercools, that is, rapidly drops the temperature of the refrigerant flowing inside from the first expansion valve and discharges the refrigerant to the evaporator 190 in the cooling cycle, or supercools the refrigerant flowing inside from the evaporator 190 and discharges the refrigerant to the outdoor heat exchange unit 150 in the heating cycle.

The fifth expansion valve 180, as shown in FIGS. 2 and 3, is disposed between the subcooling plate heat exchanger 170 and the evaporator 190, but belongs to the indoor unit 20. Further, the fifth expansion valve 180, in the cooling cycle, operates as a main expansion valve, thereby expanding the refrigerant discharged from the subcooling plate heat exchanger 170 and discharging the refrigerant to the evaporator 190.

The evaporator 190, which is an indoor heat exchanger, operates as an evaporator that evaporates refrigerant in the cooling cycle and functions as a condenser in the heating cycle.

The heating plate heat exchanger 200, which is a main plate heat exchanger that is operated in the heating cycle, as shown in FIG. 3, performs heating and removing heat of the engine, using heat exchange between the refrigerant reduced in temperature by expanding through the third expansion valve 163 and the high-temperature cooling water discharged from the gas engine 110.

The accumulator 210 receives a gas-liquid mixture from the oil separator 133, the subcooling plate heat exchanger 170, and the heating plate heat exchanger 200, separates gas and liquid refrigerants from each other, keeps some of refrigerants, and prevents liquid back.

The refrigerant kept in the accumulator 210 is discharged to the first compressor 131 and the second compressor 132 of the compressure 130 due to suction by the first compressor 131 and the second compressor 132.

The hot water generation unit 230 includes: a hot water accumulation tank 231 that keeps and supplies initial water to the hot water pipeline and receives and keeps hot water increased in temperature; a hot water pump 233 that pumps and circulates the water in the hot water accumulation tank 231; and a hot water plate heat exchanger 232 that produces hot water by transmitting waste heat from the gas engine 110 to the water circulated by the hot water pump 232 and discharges the hot water to the hot water accumulation tank 231.

The waste heat-cooling water circulation controller 220, as shown in FIG. 6, performs control to form a first flow in which the cooling water in the waste heat-cooling water pipeline circulates through the gas engine 110, the outdoor heat exchange unit 150, and the gas engine 110 is formed and a second flow in which the cooling water circulates through the gas engine 110, the hot water plate heat exchanger 232, and the gas engine 110 is formed by the cooling water pump 110. Further, the waste heat-cooling water circulation controller 220, as shown in FIG. 5, performs control to form a first flow in which the cooling water in the waste heat-cooling water pipeline circulates through the gas engine 110, the hot water plate heat exchanger 232, and the gas engine 110, a second flow in which the cooling water circulates through the gas engine 110, the heating plate heat exchanger 220, and the gas engine 110, and a third flow in which the cooling water circulates through the gas engine 110, the outdoor heat exchange unit 150, and the gas engine 110. As described above, since the cooling water absorbing waste heat is controlled in different ways in the cooling cycle and the heating cycle, waste heat can be more efficiently used.

The waste heat-cooling water circulation controller 220 includes: a first 3-way valve 221 that receives cooling water increased in temperature by waste heat from the gas engine 110 and discharges the cooling water in a first direction and a second direction in the heating cycle and the cooling cycle; a third 3-way valve 223 that receives the cooling water discharged in the second direction and supplies the cooling water to the gas engine 110 through the hot water plate heat exchanger 232 in the cooling cycle and the heating cycle; and a second 3-way valve 222 that receives the cooling water discharged in the first direction, and discharges the cooling water to the outdoor heat exchange unit 150 in the cooling cycle and to the outdoor heat exchange unit 150 and the heating plate heat exchanger 200 in the heating cycle.

The waste heat-cooling water pump 260 pumps the cooling water in the waste heat-cooling water pipeline such that the cooling water circulates through the waste heat-cooling water pipeline, as shown in FIGS. 5 and 6.

The exhaust gas heat exchanger 270 is disposed between the waste heat-cooling water pump 260 and the gas engine 110 and controls the temperature of the cooling water flowing into the engine after exchanging heat with exhaust gas from the engine, thereby increasing the early-stage efficiency of the engine.

The generator-cooling circulation unit 240 includes: a generator-cooling water tank 241 that includes a generator-circulation cooling water pipeline through which cooling water circulates, keeps cooling water, and supplements the generator-circulation cooling water pipeline with cooling water; and a generator-cooling water pump 242 that removes the heat of the generator 120 by circulating the cooling water to the generator 120 and the generator radiator 153 of the outdoor heat exchange unit 150 through the generator-circulation cooling water pipe line.

Refrigerant circulation process in the cooling cycle by the configuration described above is described with reference to FIG. 2. When the compressure 130 is driven by the gas engine 110, the compressure 130 suctions the refrigerant from the accumulator 210.

The suctioned refrigerant is compressed to high temperature and high pressure by the compressure 130 and then flows into the 4-way valve 140 through the oil separator 133.

The high-temperature and high-pressure refrigerant supplied to the 4-way valve 140 is controlled to flow into the outdoor heat exchange unit 150 by the 4-way valve 140. Further, the refrigerant flowing in the outdoor heat exchange unit 150 is condensed, is expanded and cooled through the first expansion valve 161, and then flows into the subcooling plate heat exchanger 170.

The refrigerant flowing in the subcooling plate heat exchanger inputs refrigerant further decreased in temperature by subcooling to the evaporator 190 through the fifth expansion valve 180 and the refrigerant is evaporated by the evaporator 180 and then flows into the accumulator 210 through the 4-way valve 140. The fifth valve 180 controls the amount of the refrigerant flowing into the evaporator 190 for heating.

Refrigerant circulation process in the heating cycle by the configuration described above is described with reference to FIG. 3. When the compressure 130 is driven by the gas engine 110, the compressure 130 suctions the refrigerant from the accumulator 210.

The suctioned refrigerant is compressed to high temperature and high pressure and is then supplied to the 4-way valve 140 through the oil separator 133.

The high-temperature and high-pressure refrigerant supplied to the 4-way valve flows into the subcooling plate heat exchanger 170 through the evaporator 190 and the fifth expansion valve 180.

Some of the refrigerant discharged from the subcooling plate heat exchanger 170 expands through the second expansion valve 162 and flows into the outdoor heat exchange unit 150 and the remaining expands through the third expansion valve 163 and flows into the heat plate heat exchanger 200. The heating plate heat exchanger 200 functions as an evaporator in this process.

The refrigerant evaporated through the heating plate heat exchanger 200 and the refrigerant cooled through the outdoor heat exchange unit 150 flow into the accumulator 210.

Furthermore, the generator-cooling circulation unit 240, as shown in FIG. 4, pumps and circulates the cooling water in the generator-circulation cooling water pipeline to the generator 120, the generator radiator 153 of the outdoor heat exchange unit 150, and the generator-cooling water pump 242, thereby removing the heat of the generator 120. The inverter module 280 may be further provided in the generator-circulation cooling water pipeline, so heat generated by the inverter module can also be removed.

A cooling water circulation process for removing heat of the gas engine 100 in the heating cycle is described with reference to FIG. 5.

When the waste heat-cooling water pump 260 pumps the cooling water in the waste heat-cooling water pipeline, the cooling water in the waste heat-cooling water pipeline takes the heat from the gas engine 110. Further, some of the refrigerant increased in temperature by taking the heat from the gas engine 110 is supplied to the hot water plate heat exchanger 232 through the third 3-way valve 223 and the remaining is distributed to the heating plate heat exchanger 200 and the outdoor heat exchange unit 150 through the second 3-way valve 222.

The cooling water flowing in the hot water plate heat exchanger 232 is supplied to the hot water accumulation tank 231 of the hot water generation unit 230, heats the water flowing into the hot water plate heat exchanger 232, and then circulates to the gas engine 110 through the waste heat-cooling water pump 260.

Furthermore, the cooling water supplied to the outdoor heat exchange unit 150 with the temperature increased from the second 3-way valve 222 is cooled by exchanging heat with indoor air and then circulates to the waste heat-cooling water pump 260.

Furthermore, the cooling water supplied to the heating plate heat exchanger 200 with the temperature increased from the second 3-way valve 222 transmits heat to the refrigerant that is supplied to the heating plate heat exchanger 200 and then circulates to the waste heat-cooling water pump 260 with the temperature decreased by the heat exchange.

A cooling water circulation process for removing heat of the gas engine 100 in the cooling cycle is described with reference to FIG. 6.

When the waste heat-cooling water pump 260 pumps the cooling water in the waste heat-cooling water pipeline, the cooling water in the waste heat-cooling water pipeline takes the heat from the gas engine 110. Further, some of the refrigerant increased in temperature by taking the heat from the gas engine 110 is supplied to the hot water plate heat exchanger 232 through the third 3-way valve 223 and the remaining is distributed to the outdoor heat exchange unit 150 through the second 3-way valve 222.

The same as in heating, the cooling water flowing in the hot water plate heat exchanger 232 is supplied to the hot water accumulation tank 231 of the hot water generation unit 230, heats the water flowing into the hot water plate heat exchanger 232, and then circulates to the gas engine 110 through the waste heat-cooling water pump 260.

Furthermore, the cooling water supplied to the outdoor heat exchange unit 150 with the temperature increased from the second 3-way valve 222 is additionally cooled by exchanging heat with indoor air and then circulates to the waste heat-cooling water pump 260.

It would be easily understood by those skilled in the art that the present invention is not limited to representative preferred embodiments described above and may be changed, replaced, and modified in various ways without departing from the spirit of the present invention. The change, replacement, and modifications should be construed as being included in the present invention as long as they are included in the following claims.

What is claimed is:

1. A gas engine driven heat pump system with a generator, the system including a gas engine, an outdoor heat exchange unit performing heat exchange with external air, an expansion valve unit expanding and discharging refrigerant condensed by the outdoor heat exchange unit in a cooling cycle and a heating cycle, and a heating plate heat exchanger transmitting heat to the refrigerant decreased in temperature and expanded by the outdoor heat exchange unit and the expansion valve unit, the system comprising:
a generator driven by the gas engine to generate power; and a generator-cooling circulation unit including a cooling water tank supplementing a generator-circulation cooling water pipeline, which connects the generator and the outdoor heat exchange unit in circulation, with cooling water using pressure generated in the a generator-circulation cooling water pipeline, and a generator-cooling water pump pumping the cooling water in the generator-circulation cooling water pipeline to circulate the cooling water to the generator and the outdoor heat exchange unit.

2. The system of claim 1, wherein the outdoor heat exchange unit includes a generator radiator discharging heat of the cooling water increased in temperature through the generator, in the generator-circulation cooling water pipeline, to the outside.

3. The system of claim 1, further comprising:
a hot water generation unit including a hot water accumulation tank keeping water to be heated and receiving and keeping heated hot water, a hot water pump circulating water in the hot water accumulation tank through a hot water pipeline, and a hot water plate heat exchanger receiving the water supplied by the hot water pump and heated cooling water and transmitting heat of the heated cooling water to the water supplied by the hot water pump;
an engine-cooling water tank keeping cooling water and supplementing a cooling/heating pipeline with cooling water;
a waste heat-cooling water circulation controller controlling cooling water to form a first flow in which cooling water in a waste heat-cooling water pipeline circulates through the gas engine, the hot water plate heat exchanger, and the gas engine and a second flow in which the cooling water circulates through the gas engine, the outdoor heat exchange unit, and the gas engine in a cooling cycle in the cooling cycle, and controlling cooling water to form a first flow in which the cooling water circulates through the gas engine, the hot water plate heat exchanger, and the gas engine and a second flow in which the cooling water circulates through the gas engine, the outdoor heat exchange unit, the heating plate heat exchanger, and the gas engine in the heating cycle; and
a waste heat-cooling water pump pumping the cooling water in the waste heat-cooling water pipeline to circulate the cooling water.

4. The system of claim 3, wherein the waste heat-cooling water circulation controller includes:
a first 3-way valve receiving cooling water increased in temperature by waste heat from the gas engine and discharging the cooling water in a first direction and a second direction in the heating cycle and the cooling cycle;
a third 3-way valve receiving the cooling water discharged in the second direction and supplying the cooling water to the gas engine through the hot water plate heat exchanger in the cooling cycle and the heating cycle; and
a second 3-way valve receiving the cooling water discharged in the first direction, and discharging the cooling water to the outdoor heat exchange unit in the cooling cycle and to the outdoor heat exchange unit and the heating plate heat exchanger in the heating cycle.

5. The system of claim 3, further comprising an exhaust gas heat exchanger controlling temperature of cooling water flowing into an engine by transmitting heat of engine exhaust gas to the cooling water in early-stage operation.

6. The system of claim 1, further comprising an inverter module disposed in the generator-circulation cooling water pipeline to remove heat discharged from the cooling water.

7. The system of claim 1, wherein the compressor is driven by power from the engine.
